(19) United States
(12) Patent Application Publication
(10) Pub. No.: US 2018/0192600 A1
(43) Pub. Date: Jul. 12, 2018

(54) Hydroponic environmental controller with management reporting and logging

(71) Applicant: Yvette Seifert Hirth, San Francisco, CA (US)

(72) Inventor: Yvette Seifert Hirth, San Francisco, CA (US)

(21) Appl. No.: 15/009,311

(22) Filed: Jan. 28, 2016

(51) Int. Cl. A01G 31/02; G05B 15/02

(52) U.S. Cl. CPC A01G 31/02; G05B 15/02

(57) ABSTRACT

A hydroponic environmental control system that automates the management of the air, temperature, CO2, lighting, and humidity for the optimum growth of plants in a hydroponic growing environment according to user-specified parameters with full logging and reporting capabilities is presented. The device is comprised of digital circuitry that reads sensor information and turn fans on/off, open/close CO2 valves, starts/stops dehumidification, and turns lights on/off. Due to the electrical and humid environment in which the device will be operating, the device is comprised of two modules, each of which is designed for a different environmental setting: (a) the control module, the module with which the user interfaces, is normally located in or near to the hydroponic environment and is thus designed to resist humidity; and (b) the power module, normally located in a dry area, supplies power to both itself and the control module, and contains all of the line-voltage interfaces.

### BACKGROUND

### Technical Field

The present device relates to a hydroponic environmental controller with management reporting and logging.

### Background

Hydroponics provides for the growth of both flowering and non-flowering plants. If a plant is a flowering plant, then the plant may require different environments for vegetative growth and flowering. Vegetative growth in plants is triggered by more than twelve hours a day of sun or equivalent light. Flowering plants begin their flowering process when the light exists for less than twelve hours a day. Thus, in order for a flowering plant to move from the vegetative growth stage to the flowering stage requires that the times of operation change for the light source.

Environmental control devices are well-known in the art; for example, thermostats, CO2 injection “timers”, and CO2 injection “level sensors”. CO2 injection timers known in the art run on periodic intervals; for example, “every 20 minutes, open the CO2 valve for 1 minute”, but are insensitive to CO2 levels and are not real-time-based. CO2 injection level sensors known in the art open the CO2 valve when the CO2 level drops below a user-preset level, and close the CO2 valve when the CO2 level rises above another user-preset level, but are not chronologically-based and thus they are not real-time-based.

### SUMMARY

A hydroponic environmental control device that automates the management of the air, temperature, CO2, lighting, and humidity for the optimum growth of plants in the grow space according to user-specified parameters with full logging and reporting capabilities is presented. The device is comprised of digital circuitry that reads sensor information and turn fans on/off, open/close CO2 valves, starts/stops dehumidification, and turns lights on/off. Due to the electrical and humid environment in which the device will be operating, the device is comprised of two modules, each of which is designed for a different environmental setting: (a) the control module, the module with which the user interfaces, is normally located in or near to the hydroponic environment and is thus designed to resist humidity; and (b) the power module, normally located in a dry area, supplies power to both itself and the control module, and contains all of the line-voltage interfaces.

The device logs the actions taken along with the then-current clock setting in nonvolatile memory and then displays them in a zoomable, viewable format so as to focus on the actions taken and results achieved either by zooming in to focus on a given day, or zooming out to shift the focus to longer time periods.

Environmental controllers offer many labor-saving benefits, such as not having to manually monitor the CO2 density in the grow space. The present device is digitally-based, addresses the needs of all users with grow spaces, and uses energy-and-carbon-saving techniques previously unknown or unaddressed.

### BRIEF DESCRIPTION OF THE DRAWINGS

Various other objects, features, and attendant advantages of the present device will become more fully appreciated as the same becomes better understood when considered in conjunction with the accompanying drawings, in which like reference characters designate the same or similar parts throughout the several views, and wherein:

FIG. 1 shows the assembled power module;

FIG. 2 shows the assembled control module;

FIG. 3 shows the electrical and communications connectors mounted on the power module;

FIG. 4 shows the electrical and communications connectors mounted on the control module;

FIG. 5 shows the components of the power module;

FIG. 6 shows components of the control module;

FIG. 7 shows the connections between the power module and the control module;

FIG. 8 shows the top-level presentation screen of the device after power-on and setup has been completed;

FIG. 9 shows the main menu screen of the device after the user has tapped on the main menu icon;

FIG. 10 shows the processing steps involved with device configuration;

FIG. 11 shows the System Parameters menu;

FIG. 12 details the logic required to raise the CO2 density to 730 ppm; and

FIG. 13 shows a sample event log displayed on the touch screen.

### DEFINITIONS

“CPU” shall be defined as either a microprocessor, or a microcontroller, or a programmable logic controller, or as some combination of one or more of the above-listed components in a configuration that will run software program instructions;

“Disk” shall be defined as the solid-state disk drive(s) of any form factor, including microSD cards, SD cards, compact flash cards, et al, that is mounted on the printed circuit board or otherwise inside the device and is/are thus included within the device;

“Event” shall be defined as any action taken with respect to the devices being controlled by the device or any signal received by the device;

“Grow Space” shall be defined as the volume of space delimited by and consumed by the hydroponic growing environment;

“Non-volatile memory” shall be defined as either the electronically erasable programmable rewriteable memory contained within the CPU or otherwise within the device, for example, EEPROM, or FLASH memory;

“Powcom” shall be defined as either or both of the two multi-conductor cables which run between both the power and control modules and the power and flow modules. The powcom cables perform both a power-supply function, supplying two different DC voltages, as well as a communications function, supplying I2C communications wiring carrying the various I2C signals/data between the components;

“Read from disk” shall be defined as the combination of software commands that initiate the read command(s) to the disk and wait for it/them to complete;

“Read from nonvolatile” shall be defined as the combination of software commands that initiate the read command to EEPROM or FLASH and wait for it to complete;

“Vendor” shall be defined as any manufacturer of CPU devices;

“Write to disk” shall be defined as the combination of software commands that initiate the read and write command(s) to the disk and wait for it/them to complete; and

“Write to nonvolatile” shall be defined as the combination of software commands that initiate the write command to EEPROM or Flash and wait for it to complete.

### DETAILED DESCRIPTION

A hydroponic environmental control device that automates the management of the air, temperature, CO2, lighting, and humidity for the optimum growth of plants in a hydroponic growing environment according to user-specified parameters with full logging and reporting capabilities is presented. The device is comprised of digital circuitry that reads sensor information and turn fans on/off, open/close CO2 valves, starts/stops dehumidification, and turns lights on/off. Due to the electrical and humid environment in which the device will be operating, the device is comprised of two modules, each of which is designed for a different environmental setting: (a) the control module, the module with which the user interfaces, is normally located in or near to the hydroponic environment and is thus designed to resist humidity; and (b) the power module, normally located in a dry area, supplies power to both itself and the control module, and contains all of the line-voltage interfaces.

The device uses microprocessor/microcontroller technology to control the hydroponic growing environment through control of the various apparatus that affects the hydroponic growing environment. In embodiments, the device has the microcontroller continuously interrogating the sensors for their information regarding the status of the environment and a microcontroller acts as a “microprocessor work offload” device, or in other embodiments, the information gathering from the sensors is done in the microprocessor itself, using no microcontroller work offload, which becomes more useful as microprocessor speeds improve and their prices drop and thus they become more justifiable on an economic basis.

The environment management process may need to run 24×7 for vegetative growth; if flowering is scheduled, the process can begin at any user-specified time of day. In either case the device is designed to fully manage the hydroponic environment. In embodiments, the device makes possible energy-saving queries that can reduce resource costs, such as swapping dry, cool outside air for moist, hot inside air instead of using the dehumidifier. The device can time the opening and closing of the various connected equipment down to the millisecond to maximize the optimization and control processes that create and manage the resultant environment. The microprocessor logs the actions it took along with the then-current clock setting in nonvolatile memory and then displays them in a viewable format so as to focus on the actions taken and results achieved either by zooming in to focus on a given day, or out to shift the focus to longer time periods.

The device's microprocessor also performs energy- and CO2-saving calculations: avoiding use of the dehumidifier if swapping the air inside the hydroponic growing area with fresh outside air is energy-saving; and the timing of CO2 injections immediately after the fans have run so as to raise the CO2 ppm level without wasting CO2. CO2 injection timers and injection level sensors work fine, but need to be timed using a real-time clock and need to be timed to work properly in conjunction with other air-based devices (e.g., fans, dehumidifiers). If the CO2 level is being raised while the intake and exhaust fans are being run—which is entirely possible with current technology—the user is simply injecting CO2 into the world's air supply, which is undesirable. If, however, there is a central controller that refreshes the hydroponic environment's air first, and afterwards injects CO2 into the atmosphere, the amount of CO2 being lost is minimized, and further damage to earth's ecosystem is minimized.

The device contains all the necessary electronic components required to manage the environment, as well as an internal power supply. The device is intended to run 24×7 and it contains a long-duration battery to ensure the internal clock is kept running during power-off periods. When powered on, the device's microprocessor checks it's internal nonvolatile memory to see if setup has been completed, and if not, begins a setup process wherein it displays setup information for the user and asks the user to verify or optionally change the parameters shown. Once the setup check is complete, the controller module then prompts the user to begin running the environmental control program stored in nonvolatile memory.

In combination with the attached drawings, the technical contents and detailed description of the present device are described hereinafter according to a number of embodiments, but should not be used to limit its scope. Any equivalent variation and modification made according to appended claims is all covered by the claims of the present device.

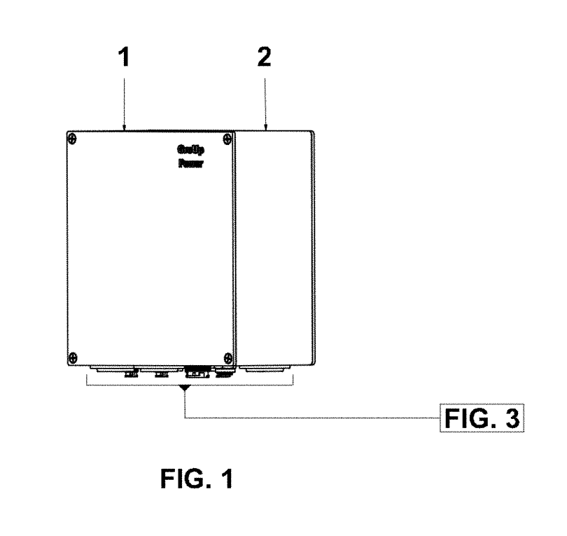

Referring now to FIGS. 1-13, the components of the environmental controller device are shown.

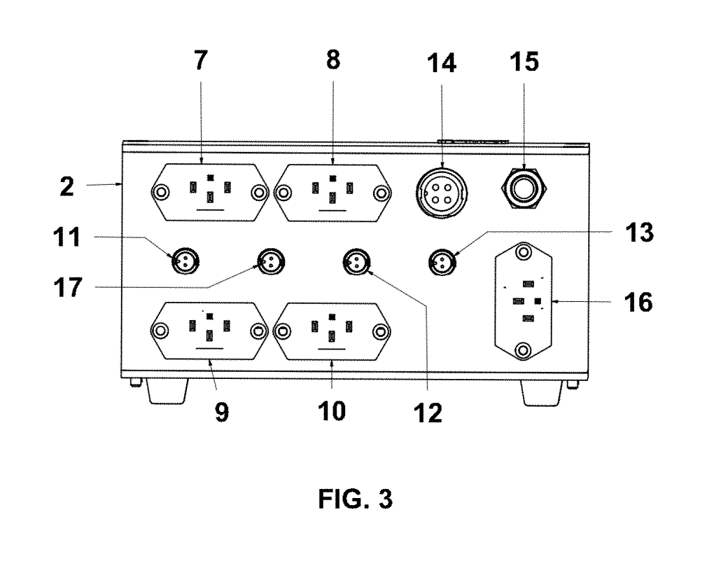

In FIG. 1 the front of the power module is shown. The front cover 1 encloses the casing 2 which may house the connectors, as explained in FIG. 3.

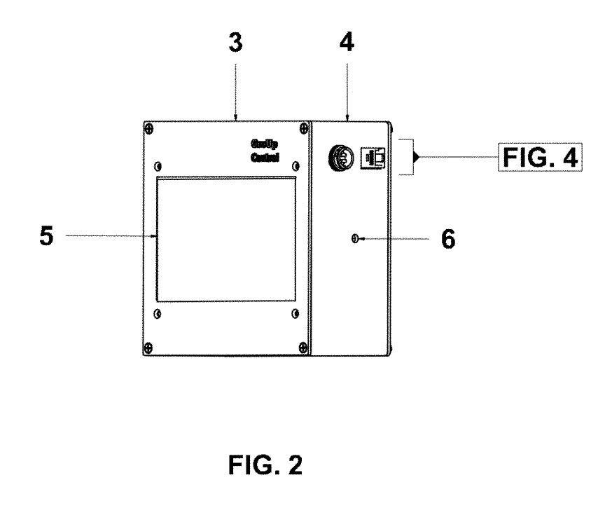

In FIG. 2 the front of the control module is shown. The front cover 3 encloses the casing 4 which may house the touch screen 5. The casing may be rotated along the zy axis using the two pivot mounts 6 that are mounted on each side of the casing so as to make the display easier to view in varying light.

In FIG. 3 the bottom of the power module is shown along with all of the connectors of the power module. The various components that may play a role in the function of the power module are mounted on or inside the casing 301 and may be:
a plurality of female IEC connectors 7-10 that may supply switched power to:
   the intake exhaust fans 7;
   the dehumidifier 8;
   the air movement fans 9; and
   the lights 10;
the four low-voltage DC connectors for:
   the indoor temperature and humidity sensor 11;
   the outdoor temperature and humidity sensor 17;
   the CO2 sensor 12; and
   the CO2 solenoid-controlled valve 13;
the powcom connector 14;
a circuit breaker reset button 15; and
the male line-voltage input IEC connector 16.

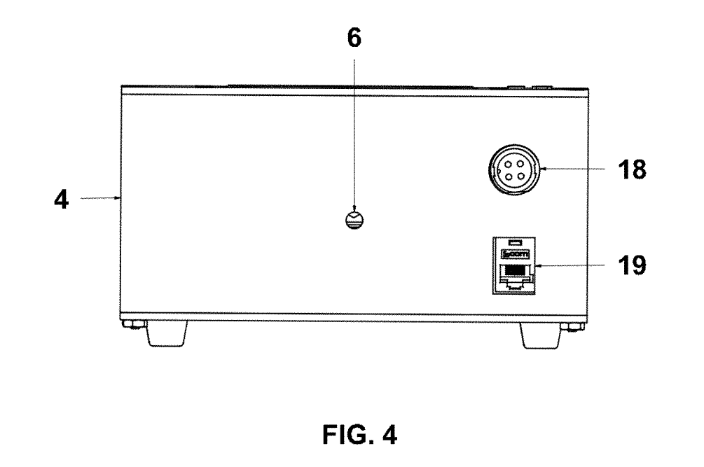

In FIG. 4 the right-hand side of the control module is shown. The control module 4 may obtain its power and communication facilities from the power module using the powcom cable which connects to 18, and may communicate via the internet using an internal wifi module or via a standard category 5 or category 6 cable connected to the Internet connector 19. The internet connector 19 may be used when the user chooses a wired connection and thus chooses to not use the internal wifi connection.

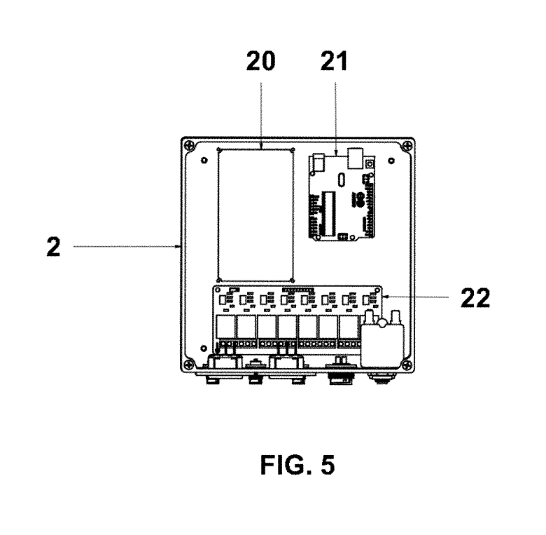

In FIG. 5 the inside of the power module is shown. In embodiments, the various components that may play a role in the function of the device inside the casing 2 are:
the power supply that converts line voltage to internal DC voltages 20;
the motherboard with CPU 21; and
a bank of relays that may switch power to controlled devices 22.

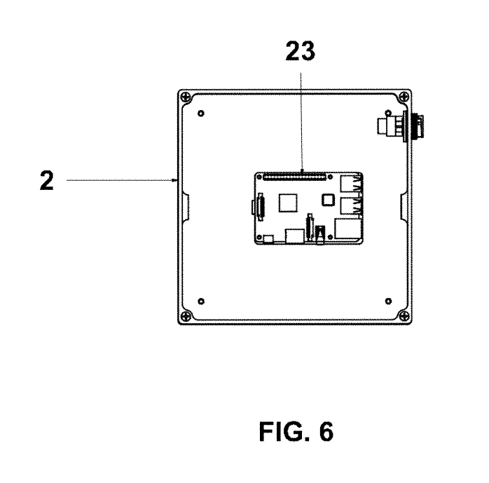

In FIG. 6 the inside of the control module is shown. In embodiments, the casing 4 houses the components described above in FIG. 2 and the connectors described above in FIG. 4 as well as the control module CPU 23.

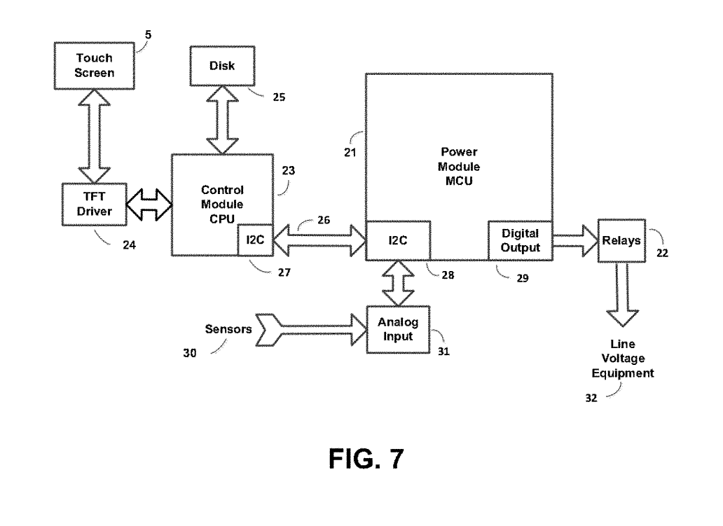

In FIG. 7, the internal communications between modules is shown. The user makes choices and enters them on the control module's touch screen 5 which may communicate them to the touch screen's TFT driver 24 which may then forward them to the control module CPU 23. The program code running on the control module CPU 23 may save these changes to disk 25 and may send any commands or communication necessary via its I2C interface 27 and the powcom cable 26 to the power module's CPU 21 via its I2C interface 28 which may process them and manage the equipment hooked up to the power module 32 through the power module's relays 22 controlled by the power module CPU's digital output 29. The power module may respond with success or failure to the control module via the I2C interface:powcom combination 28 26 27. The power module may read its sensors 30 via its analog input 31 that communicates via I2C 28 back to the control module via the I2C interface:powcom combination 28 26 27.

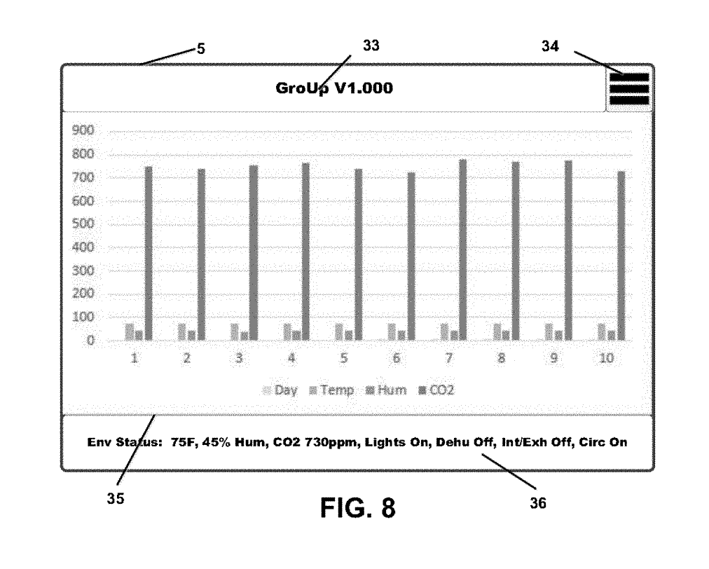

In FIG. 8, the program's “top level” display is shown displayed on the touch screen 5. The “top level” display may be presented to the user after power on if setup is complete, and this is the display from which the user can view the status of the environment. The product name and software version may be displayed in the header bar 33. The image containing three horizontal bars in the upper right-hand corner 34 may be the icon for the Main Menu, and tapping the main menu icon displays the Main Menu. The vertical bars 35 may display the results of the current and previous environmental control efforts, with the Temperature, Humidity, and CO2 level in ppm of the current and past environments clearly shown. In embodiments, the status bar 36 shows the current status of the environment: it is 75F with 45% humidity in the growing environment, the CO2 level is 730 ppm, the lights are on, the dehumidifier is not running, the intake and exhaust fans are off, and the air circulation fans are running.

To change the view the results of previous mixing processes, the user can pinch the display, which will zoom out the area that was pinched; or the user can stretch the display, which will zoom in the area that was stretched. The pinch and stretch gestures used are similar to pinch and stretch gestures used on tablet PC's.

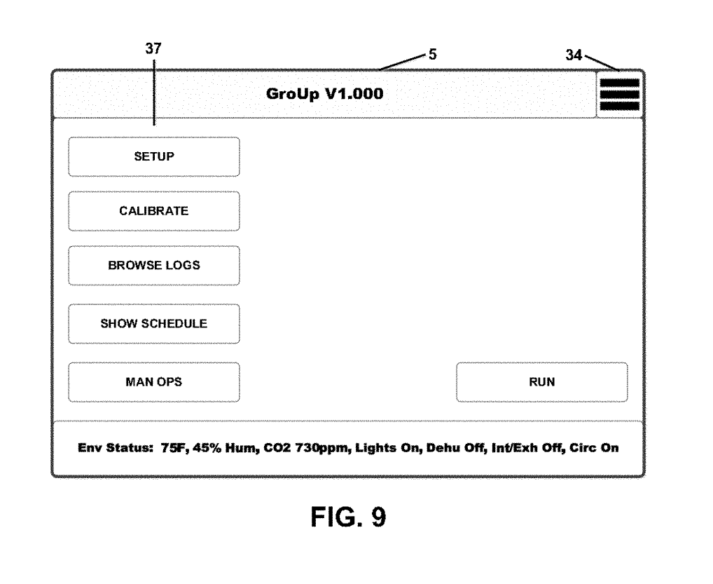

In FIG. 9, the program's main menu 37 viewable on the touch screen 5 are shown. This menu may be presented to the user when the user taps on the Main Menu icon 34 in the upper right-hand corner of the touch screen 5. Once presented with the Main Menu, the user makes a choice by tapping the appropriate menu option. The available actions may be:
Setup;
Calibrate;
Browse Logs;
Show Schedule;
Manual Operations; and
Run.

If the user taps any menu option other than Run, the user may then be presented with a menu for that option on the touch screen 5. If the user taps Run, the user exits from the Main Menu, and the user then is placed into the main display screen for the device 35 as shown in FIG. 8.

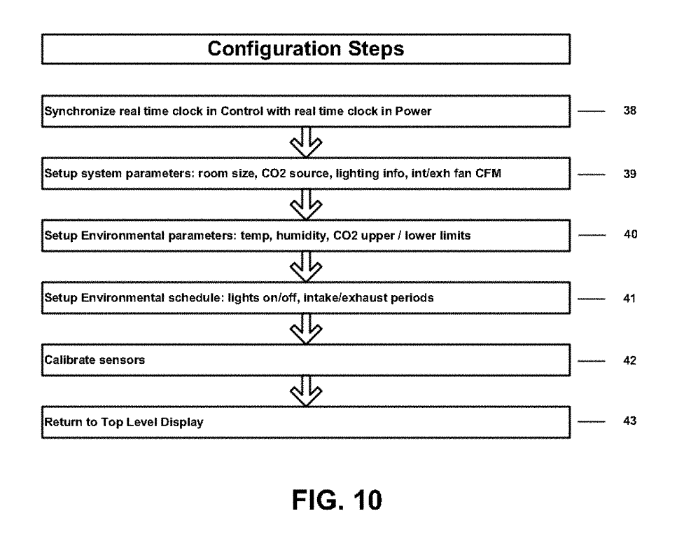

In FIG. 10, the program steps to validate the configuration are shown. After power on, the program may first determines the time and synchronizes the CPU in the power module via communications routed over the communications conductors in the multi-conductor power cable so both modules share the same time setting 38. As the modules are connected via serial communications using an electrical cable, the synchronization effort requires that the power module compensates for the signal delays experienced during inter-module communications. The compensation is the sum of the time it takes to transmit the number of bytes being transmitted plus the code overhead to create the communications data plus the code overhead to process the communications data and update the clock. The power module adds this predetermined amount of time calculated during device manufacture to the incoming timestamp, and then the result is stamped into the power module's real time clock. While the result cannot be made accurate to the microsecond due to the unknowns and vagaries of software path lengths, it is accurate to the millisecond, which is sufficient for environmental equipment control timing.

The program may then query internal non-volatile memory to inspect the system configuration and environmental schedule. If the configuration is not complete, the program may prompt the user with the thus-far-known system configuration information 39 and environmental schedule information 40 and may further prompt the user to optionally change what portions of the above are known and may force the user to complete the remainder of the schedule using the Setup menu option from the main menu 37 displayed on touch screen 5.

Once the system parameters and environmental schedule are complete, the system is ready for use.

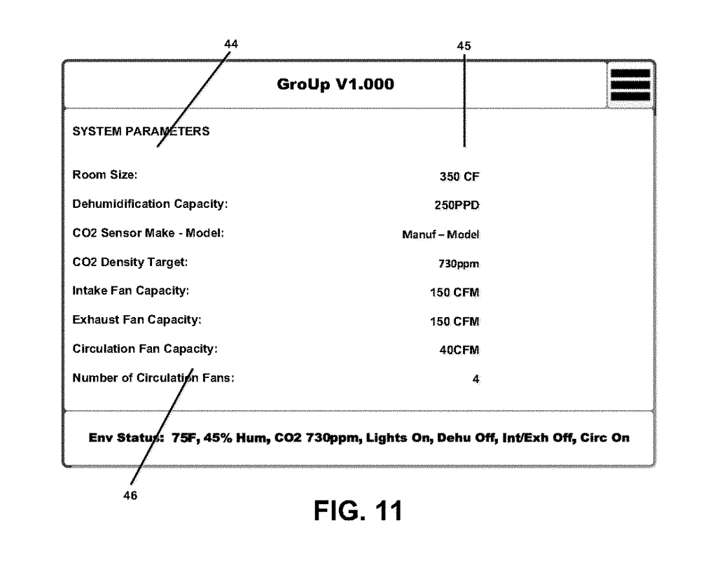

In FIG. 11, the system configuration menu of the configuration program code is shown.

The system configuration menu 44 45 may specify static items in the system configuration parameter area 46; i.e., items that will not normally change as schedules change, including:
the size of the grow space in cubic feet or cubic meters;
the CF/M or M³/m of the dehumidification equipment;
the type of CO2 sensor being used; the target CO2 density, in ppm, when CO2 replenishment operations are being performed; and
the CF/M or M³/m of the fans being used and the number of fans that are being used.

Once the system configuration process is complete the user may begin using the system.

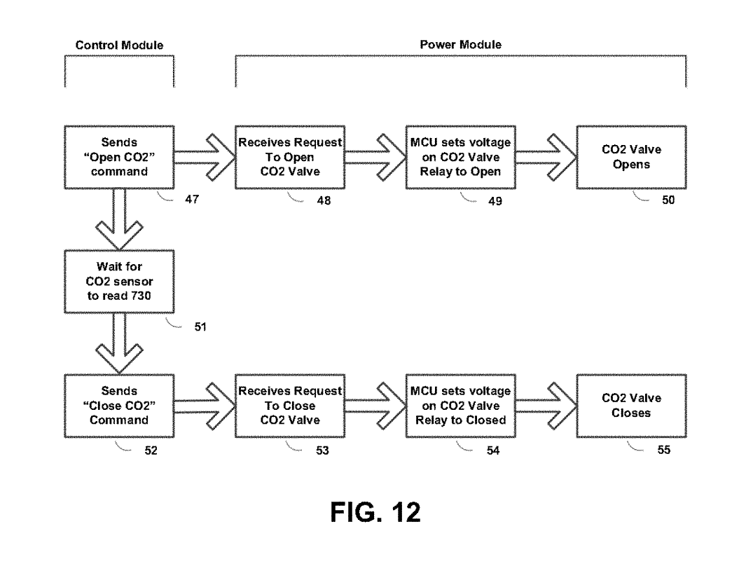

In FIG. 12, an embodiment of the flow of control to raise the CO2 level to 730 ppm is shown. The process may begin by the CPU in the control module issuing a command to the power module to open the CO2 valve 47. The power module receives the command 48 and its CPU sets the voltage on the CO2 valve solenoid relay to open 49 and the CO2valve opens 50. When the control module determines that the CO2 level has reached 730 ppm 51, it issues a command to the power module to close the CO2 valve 52. The power module receives the command 53 and its CPU sets the voltage on the CO2 valve solenoid relay to closed 54 and the CO2 valve closes 55.

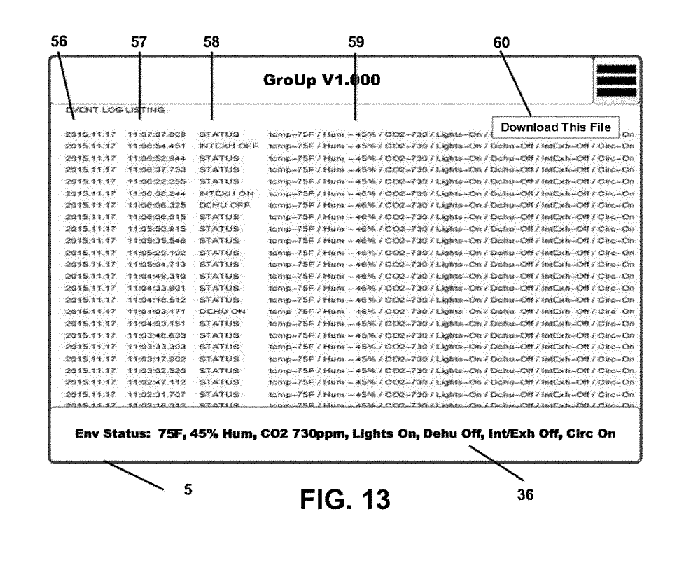

In FIG. 13, the log information display generated by the device that may be viewable on a standard computer browser is shown. In the output shown on the touchscreen 5, the date 56, time 57, action(s) taken 58, and status 59 of the device are shown. The latest status 59 may match the information shown in the device's status bar 36.

Log information is shown as a sequential list of events ordered by decreasing date and time. The user can scroll up or down to display up-to-date (top) or past (lower) log information. By browsing the log information users can see what actions are being taken and in the event things go wrong the user can also answer “what happened when?” queries.

FIG. 13 also shows the download feature for downloading the event file in .zip file format 60. In embodiments, the download button appears on industry-standard browsers running on external computers; i.e., computers that are browsing the device using the device's internet communications feature and industry-standard browsers. These external computers can be touch-enabled devices or mouse-enabled devices. The downloaded file is in .csv format and can be used in spreadsheets or other csv-capable devices for downstream analysis. The download button, while shown here for inclusiveness, is not visible on the device's touch screen 5 itself.

1. A hydroponic environmental control system, comprising:
a controller, including:
at least one processor;
at least one permanent storage medium;
at least one non-volatile memory;
at least one display;
at least one input device;
a non-volatile storage device that contains a log of the events that took place while controlling the hydroponic environment;
program code for controlling the hydroponic environment;
at least one environmental sensor for collecting environmental data and transmitting the collected environmental data to said controller; and
at least one environmental control component wherein said at least one environmental control component is communicatively coupled with said controller for transmitting control signals to said environmental control component responsive to receipt of the collected environmental data by said controller.

2. The hydroponic environmental control system of claim 1, wherein each of said at least one processor comprises one of: a microprocessor; a microcontroller; and a CPU.

3. The hydroponic environmental control system of claim 1, wherein said system comprises a power supply, wherein said power supply comprises one of a battery and an external AC line power source.

4. The hydroponic environmental control system of claim 1, further comprising at least one enclosure defining at least one interior space for receiving:
said processor;
said permanent storage medium;
said non-volatile memory;
said display;
said input device; and
said non-volatile storage device.

5. The hydroponic environmental control system of claim 1, wherein said controller and said power supply are housed in separate compartments and are communicatively coupled using at least one of electrical and optical connections.

6. The hydroponic environmental control system of claim 1, wherein said at least one environmental sensor comprises at least one of: a temperature sensor; a humidity sensor; and a CO2 sensor.

7. The hydroponic environmental control system of claim 1, wherein said system communicates with the internet using one or both of wifi and wired connections.

8. The hydroponic environmental control system of claim 1, further comprising at least one of: intake fans; exhaust fans; and grow space air movement fans, wherein said fans are under the control of said controller.

9. The hydroponic environmental control system of claim 1, further comprising HVAC equipment, said HVAC equipment comprising at least one of a dehumidifier and an air conditioner, wherein said HVAC equipment is under the control of said controller.

10. The hydroponic environmental control system of claim 1, further comprising a plurality of lighting devices within a grow space, wherein said plurality of lighting devices is under the control of said controller.

11. The hydroponic environmental control system of claim 1, further comprising at least one solenoid controlled valve, wherein said solenoid controlled valve controls the amount of CO2 being injected into a grow space and is under the control of said controller.

12. The hydroponic environmental control system of claim 1, wherein said program code for controlling the hydroponic environment comprises program code for giving users the ability to view any of:
current temperature;
current humidity;
current CO2 density;
on or off status of lights;
on or off status of a dehumidifier;
on or off status of intake and exhaust fans;
on or off status of circulation fans; and
said log.

13. The hydroponic environmental control system of claim 1, wherein said program code for controlling the hydroponic environment comprises program code for:
displaying a main menu for providing user access to further menus for setup, calibration, log browsing, scheduling, and manual control over connected devices;
synchronizing any real time clock located within the device;
at least one of adding and modifying information that the device contains regarding size of said hydroponic environment;
receiving user input for specifying a type of CO2 source;
receiving user input for specifying a type of lighting used; and
receiving user input for specifying the volumetric capacity of input, exhaust, and circulation fans.

14. The hydroponic environmental control system of claim 1, wherein said program code for controlling the hydroponic environment comprises program code for receiving user input regarding any of:
a desired temperature;
desired lower and upper CO2 density limits;
a start time lighting is to turn on;
the number of hours the lighting is to remain on;
a maximum humidity desired; and
intake and exhaust fan timing.

15. The hydroponic environmental control system of claim 1, wherein said program code for controlling the hydroponic environment comprises program code for calibrating any of:
temperature sensors;
humidity sensors; and
CO2 sensors.

16. The hydroponic environmental control system of claim 1, wherein said program code for controlling the hydroponic environment comprises program code for comparing energy usage over time used to exchange air in the grow space with outside air versus energy usage over time spent dehumidifying inside air when the outside air is cooler than the inside air and when the outside air is dryer than the inside air.
